(19) United States
(12) Patent Application Publication
(10) Pub. No.: US 2005/0072915 A1
(43) Pub. Date: Apr. 7, 2005

(54) Methods and apparatus for self-optimization of electrospray ionization devices

(75) Inventors: John T. Stults, Redwood City, CA (US); Jonathan C. Heller, San Francisco, CA (US)

Correspondence Address: WILSON SONSINI GOODRICH & ROSATI, 650 PAGE MILL ROAD, PALO ALTO, CA, 943041050, US

(73) Assignee: Biospect Inc., South San Francisco, CA (US)

(21) Appl. No.: 10/681,742

(22) Filed: Oct. 7, 2003

(51) Int. Cl. H01J 49/04

(52) U.S. Cl. 250/288; 250/282

(57) ABSTRACT

An automated electrospray ionization (ESI) device and related methods to optimize electrospray interface conditions for mass spectrometric analysis. The optimization process can be performed with calibration or optimization solutions that produce expected ESI parameters such as an ESI signal or an ion current. The ESI device may include an input/output (I/O) controller that is coupled to an electrospray assembly including an XYZ stage for positioning an electrospray emitter relative to a mass spectrometer orifice. The I/O controller may be connected to a power supply for applying an adjustable electrospray ionization voltage, and an adjustable flow regulator that alters the flow of solution by modifying applied voltage and/or pressure. A central processing unit instructs the I/O controller to control selectively the electrospray assembly based on the resultant signals from the mass spectrometer or the ion currents within the mass spectrometer in accordance with a predetermined optimization algorithm. The resulting ESI signal or ion currents are monitored and provide feedback to the I/O controller which can automatically instruct selected system components to make adjustments as needed to attain optimal settings that produce expected ESI signals or ion currents in the mass spectrometer for selected solutions.

### FIELD OF THE INVENTION

The invention relates to electrospray ionization mass spectrometry. More particularly, the invention relates to self-optimization apparatus and improved methods for performing electrospray ionization for mass spectrometric analysis.

### BACKGROUND OF THE INVENTION

Electrospray ionization mass spectrometry requires extensive optimization of electrospray interface conditions and this optimization process presents a significant challenge. Whenever a variable or component of the electrospray interface is changed, a variety of adjustments is consequently required thereafter. For example, an electrospray ion source may be interfaced to a mass spectrometer to deliver solution ions into the mass spectrometer orifice or capillary entrance. The ions created by the source are then swept into the mass spectrometer for analysis. During the course of experimentation, it is often necessary however to change and physically reposition system components, for example, to analyze another solution or sample. In some instances, an upstream solution delivery component may be substituted or replaced, or it may become necessary for one or more electrospray needles to be swapped or repositioned relative to the mass spectrometer. For applications where even the same electrospray needle is used, the positioning of the needle may be changed nonetheless to redirect ionization spray into the mass spectrometer in order to optimize the detected signal. Other variables affecting the electrospray such as particular flow rates, voltages, or solvent composition may further require adjustment for each type of selected calibration or sample solution in order to optimize the detected signal.

An electrospray ionization source assembly consists of a capillary or microfluidics channel connected to an emitter, which could be a pulled capillary, a tip on a microfluidics device, or a laser etched capillary or channel. The electrospray ionization source is interfaced to a mass spectrometer by placing it near the entrance or orifice of the mass spectrometer. Once a sufficient voltage difference is created between the emitter and the orifice, the solution presented to the emitter through the capillary or channel is ionized, forms a Taylor cone from which a spray of droplets is generated, and ions are formed that move toward the mass spectrometer orifice. Ions created by the source are transported into the orifice and then typically through a series of mass spectrometer ion optical components until they reach the detector. The electric field in the region of the emitter and orifice as well as the flow rate of the solution in the capillary determine how well the solution constituents are ionized and how well ions from the solution are captured by the mass spectrometer. The electric field is primarily determined by the position of the emitter with respect to the mass spectrometer orifice, the geometric configuration of the emitter and orifice, and by the voltage difference between the emitter and the orifice.

To detect optimal signals in the mass spectrometer, the electrospray ionization must be optimized. Typically this is done experimentally, by ionizing either a calibrant solution or a sample solution, observing the signal or formation of the Taylor cone, and manually adjusting the position, ionization voltage and flow rates. If a calibrant solution is used, a sample would subsequently be sprayed using the conditions determined by the calibrant. The optimized electrospray produces one or more of the following characteristics: (a) increased analyte signal(s), (b) reduced background signals, (c) greater signal stability, (d) greater spray stability, (e) greater spray current. Alternately, the optimized electrospray will produce signals for the calibrant(s) or background that fall within a set of predetermined optimal values. The calibrant(s) may also serve to calibrate the mass axis. After the mass spectrum for a given sample is determined, adjustments must be made in order to deliver an optimal electrospray of yet another solution. In the case of a one-time use microfluidics device, extensive optimization must be carried out prior to each sample analysis. The optimization process is often a repetitive and time-consuming procedure requiring significant time, expertise, and manual effort. The physical movement of the emitter position, the adjustment of the ionization voltage and the adjustment of the flow rates are modified as needed with the aid of a microscope, charge coupled device (CCD) camera, by observing the ion current at any of several stages within the mass spectrometer, or by observing the resultant mass spectrum during the optimization process. Accordingly, a significant amount of time, effort and expertise are needed for the electrospray optimization step alone. An improved system is therefore needed for optimizing electrospray ionization mass spectrometry procedures.

### SUMMARY OF THE INVENTION

The invention provides methods and apparatus related to microfluidic chips and electrospray ionization applications. Various aspects of the invention can be appreciated individually or collectively to provide an effective interface for microfluidic systems and mass spectrometers or other analytical devices. It shall be understood that particular features of the described embodiments of the invention herein may be considered individually or in combination with other variations and aspects of the invention.

A preferable embodiment of the invention provides an electrospray ionization device that can be optimized for mass spectrometric analysis. The optimization process can be performed with a calibration or optimization solution that produces an expected electrospray ionization (ESI) signal or an expected ion current at any of the many locations in a mass spectrometer. Such ion currents could be measured, for example, at the entrance orifice or capillary, after the entrance capillary, after a first RF guide, or at other places within the mass spectrometer. A microfluidic chip formed with an electrospray emitter and containing the calibration solution can be connected to the calibration solution which is positioned relative to the receiving orifice of the mass spectrometer. An input/output (I/O) controller may be coupled to an electrospray assembly and components thereof for controlling the spraying process. For example, the I/O controller may be coupled or in communication with an XYZ stage to position an electrospray emitter relative to an entrance of the mass spectrometer. A power supply connected to the microfluidic chip may also be controlled by the controller for applying an adjustable electrospray ionization voltage. In addition, the I/O controller can direct an adjustable flow regulator connected to the microfluidic chip to alter pressure and/or applied voltages as needed for managing flow of the calibration solution. A central processing unit instructs the I/O controller to control selectively the electrospray assembly based on the resultant signals from the mass spectrometer or the ion currents within the mass spectrometer. The central processing unit includes or can be coupled to a memory having an optimization algorithm for optimizing electrospray conditions of the calibration solution. The electrospray ionization process can be monitored so that certain variables can be adjusted accordingly to obtain an optimal electrospray setting or range of settings. The resulting ESI signal or ion currents can be monitored and provide feedback to the I/O controller which can automatically instruct the electrospray assembly and components thereof to make adjustments as needed to attain optimal settings that produce the expected ESI signals or ion currents in the mass spectrometer for selected calibration solutions.

In accordance with another aspect of the invention, methods are provided for obtaining optimal electrospray ionization conditions using a calibration standard that generates expected ESI signals and ion currents in a mass spectrometer. An electrospray ionization interface is assembled that includes an ESI microfluidic chip for spraying a calibration standard into a nearby mass spectrometer which measures ESI signals or ion currents generated by the calibration standard. A set of initial spray conditions may be established including an initial position, an ESI voltage and flow rate for the calibration standard. This set of initial spray conditions is then applied to the electrospray ionization interface to generate resulting ESI signals or ion currents for the calibration standard in the mass spectrometer. These ESI signals and currents for the calibration standard in the mass spectrometer are monitored. Based on the resulting ESI signals or ion currents, selected electrospray conditions can be adjusted in order to obtain the expected ESI signal for the calibration standard. The electrospray voltage, position of the microfluidic chip and/or flow rate can be adjusted as with other spray variables as needed until the expected ESI signal or ion current is achieved.

Another embodiment of the invention provides an electrospray optimization process using an automated self-optimizing electrospray assembly. The electrospray assembly may be connected to a controller and a computer that directs system components responsible for regulating spray conditions such as electrospray voltages, solution flow rates and positioning of an electrospray emitter. A solution is ejected from an electrospray emitter into a mass spectrometer for analysis after the assembly applies an initial set of spray conditions. The solution can have one or more characteristic electrospray ionization (ESI) parameters that can be monitored such as the electrospray current or the signal in the mass spectrometer. The resulting ESI parameter can be measured during the electrospray process and received by the computer as part of a feedback loop. Until an expected value or range of values is reached for the particular ESI parameter, the computer can instruct the controller to execute any number of adjustments to the electrospray. For example, the position of the emitter can be changed and moved closer or further away from a mass spectrometer. The flow rate for the solution and/or the electrospray voltage can be also increased or decreased as needed depending on the measured ESI parameter. During this optimization process, the computer automatically arrives at an optimal set of electrospray conditions based on monitoring of the ESI parameter and making adjustments as needed until an expected or desired value or range of values are produced for the selected solution chosen for mass spectrometric analysis.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### BRIEF DESCRIPTION OF THE FIGURES

The figures contained in this specification and features illustrated therein describe many of the advantages of the invention. It shall be understood that similar reference numerals and characters noted within these illustrations herein can designate the same or like features of the invention. The figures and features depicted therein are not intended to limit the scope and nature of the invention, and may not be drawn to scale.

FIG. 1 is the side view of a microfluidic chip and mass spectrometer interface that may be optimized in accordance with the invention.

FIG. 2 is a simplified flow chart illustrating a process in obtaining optimal electrospray ionization signals for calibration standards.

FIG. 3 is a self-optimization system provided in accordance with the invention that includes a computer and controller to perform system adjustments as needed to obtain desired mass spectrometer signals.

FIG. 4 is a graph illustrating the relationship between electrospray voltages and flow rates which can result in relatively stable and unstable ionization sprays.

FIG. 5 illustrates the effects that relevant distance between an electrospray ionization tip and a test electrode has on spray current at different flow rates.

FIG. 6 depicts a graph illustrating the dependency of the electrospray generated current and voltage at different flow rates.

FIGS. 7A-C are top views of microfluidic chips that may be incorporated into the self-optimization systems herein.

### DETAILED DESCRIPTION OF THE INVENTION

The invention provides self-optimized electrospray ionization devices and related methodologies. What may be defined as optimal spray conditions includes one or more preferred sets of inter-related measurements or characteristics that can be observed during mass spectrometric analysis such as a high, stable electrospray current and signal for a particular analyte. Optimal spray conditions can be also characterized with the formation of a stable Taylor cone and minimal or reduced background signal from a selected solvent that is used with the analyte. Methods and apparatus are provided in accordance with the invention to optimize electrospray conditions based on detecting and measuring predetermined electrospray ionization parameters associated with a particular solution undergoing mass analysis.

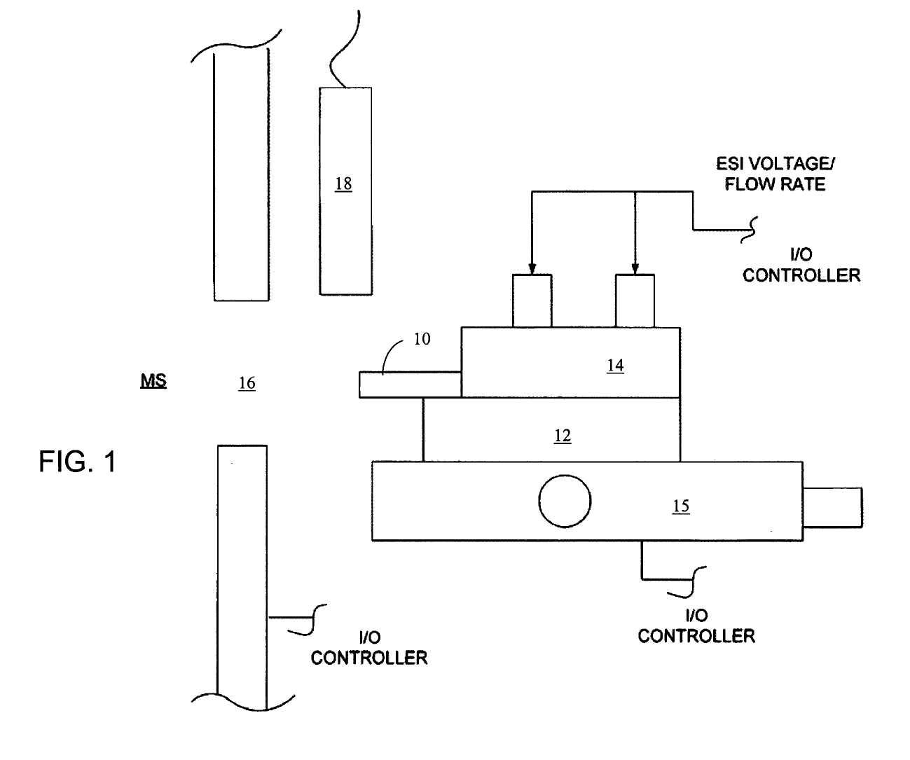

As shown, in FIG. 1, the invention may be applied to a variety of electrospray ionization (ESI) mass spectrometer interfaces to achieve optimization. A microfluidic chip or other ESI fluidic device 10 may be mounted onto a holder 12 and attached to a coupling 14 which facilitates the application of voltage and/or pressure. The microfluidic chip 10 within this electrospray assembly can be formed of a polymeric or glass material, and may include a series of fluid channels formed therein. The holder 12 supports the microfluidic chip 10 and coupling 14 which is formed with one or more reservoirs that receive various solutions such as calibration standards to be analyzed by a mass spectrometer MS. The microfluidic chip holder 12 is in turn mounted on a moveable XYZ positioner 15. The XYZ positioner 15 moves the relative position and spatial orientation of the microfluidic chip 10 in relation to the entrance or opening 16 of the mass spectrometer MS. Furthermore, the XYZ positioner 15 may include translation along one or more axis, as well as angular rotation along equatorial or azimuthal coordinates. The ESI device 10 can be thus positioned to a desired or predetermined position that may optimally direct electrospray into the mass spectrometer MS for analysis. It shall be understood that the ESI devices herein can be interfaced to a variety of mass analyzers including but not limited to Time-Of-Flight (TOF), Quadrupole, Fourier Transform (FTMS), Ion Trap, or Hybrid mass analyzers.

An input/output (I/O) controller may be connected to the electrospray assembly for selectively adjusting one or more of the interface conditions. The electrospray assembly can be directed by the I/O controller to alter the positioning of the ESI device, the applied electrospray voltage, and/or the desired flow rate. The XYZ positioner 15 can be manually positioned to a desired location or coordinate, or it may be motorized and automatically controlled by the I/O controller. While directing the XYZ positioner 15 to a desired location, the I/O controller can simultaneously or in succession instruct a series of power supplies and/or pumps also included within the electrospray assembly to deliver predetermined spray voltages and flow rates. This apparatus can include an adjustable flow regulator that controls the voltage applied to the microfluidic chip 10 and/or a mass spectrometer orifice 16, as well as selected pumps which apply pressure to fluid reservoirs residing on the microfluidic chip 10. The values for these spray parameters may be determined to provide an optimal electrospray for certain solutions. The spray conditions can be observed with a microscope or charge coupled device (CCD) camera 18 if desired for monitoring and visualization of the electrospray generated during the optimization process. The position of an ESI device 10 and selected electrospray voltage can be adjusted as needed during the process. The CCD camera 18 can be held at a desired position and angle by a mounting that also supports the microfluidic chip holder and XYZ positioner. Many commercially available CCD cameras can be selected for the apparatus and methods described herein. The optimization apparatus and methods described herein can be employed with computer systems and CCD cameras of today which offer a relatively high degree of sensitivity and can produce good quality images.

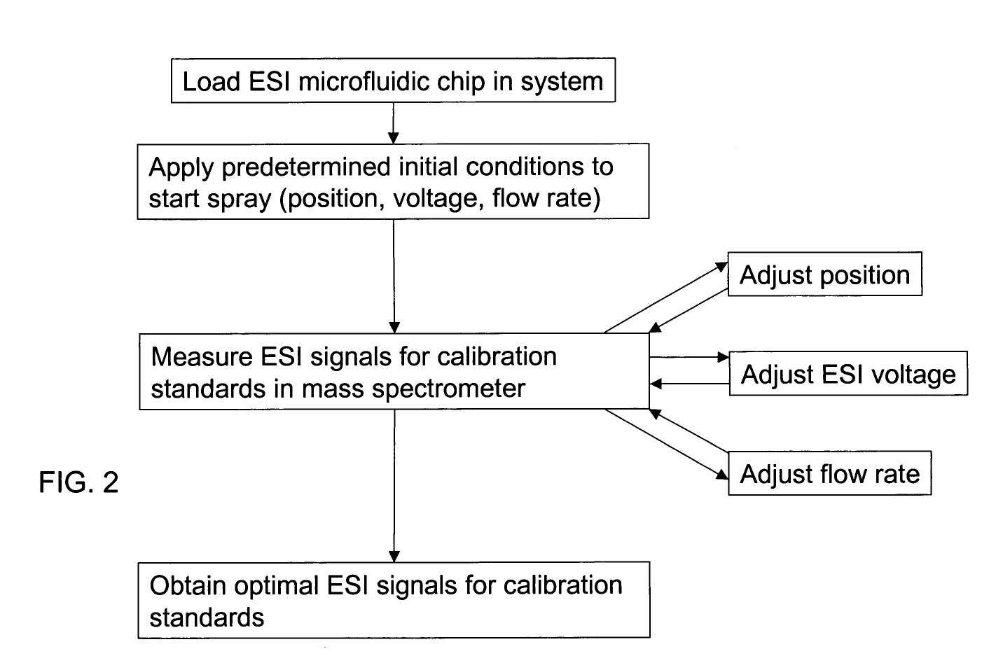

Another aspect of the invention provides various methodologies of obtaining optimal electrospray ionization (ESI) signals for selected calibration standards. As shown in FIG. 2, a preferable method of obtaining optimal ESI signals includes the initial step of loading a microfluidic chip into a selected ESI/mass spectrometer system interface. An initial set of predetermined conditions may be applied to the system to initiate electrospraying of a selected calibration standard or solution. The microfluidic electrospray tip or emitter may be connected to a liquid calibration or optimization solution. The solution contains one or more analytes that should produce a predetermined value or range for a selected ESI parameter such as an expected electrospray current or an expected signal in the mass spectrometer. For example, the ESI microfluidic chip can be moved into an initial position by instructing an XYZ stage on which it is mounted to a desired location relative to the entrance of a mass spectrometer as described herein. A controller may be selected to control the positioning of the XYZ stage. The controller may also instruct a power supply to apply an initial voltage, and a flow regulating device or voltages can be initially set to deliver a desired flow rate of selected calibration standard. The initial ESI signals generated by the initial spray conditions may be thus observed from the mass spectrometer. Based on the observation of a selected set of characteristics or properties indicative of what may be considered optimal electrospray conditions for a given calibration standard, one or more spray variables can be adjusted accordingly. In particular, the position of the ESI chip can be adjusted either closer or further from the mass spectrometer entrance or to any other desired position relative thereto. The spatial alignment may be changed during an optimization procedure by one or more motors that are controlled in a feedback loop as the spray conditions are optimized. At the same time or successively, the ESI voltage and flow rate can be adjusted higher or lower within certain ranges in order to achieve desired signals. By monitoring the ESI signals and feeding this information back to the controller, the spray conditions can be automatically adjusted in response thereto. A positive feedback loop is thus provided in accordance with this aspect of the invention to generate optimal electrospray ionization conditions once optimal signals for selected calibration standards are obtained. The signal in the mass spectrometer can then also be used for calibration of a mass axis. One or more defined analytes with known m/z ratios can be therefore selected to provide expected signals for verification of a prior calibration standard or for generation of a new mass axis calibration.

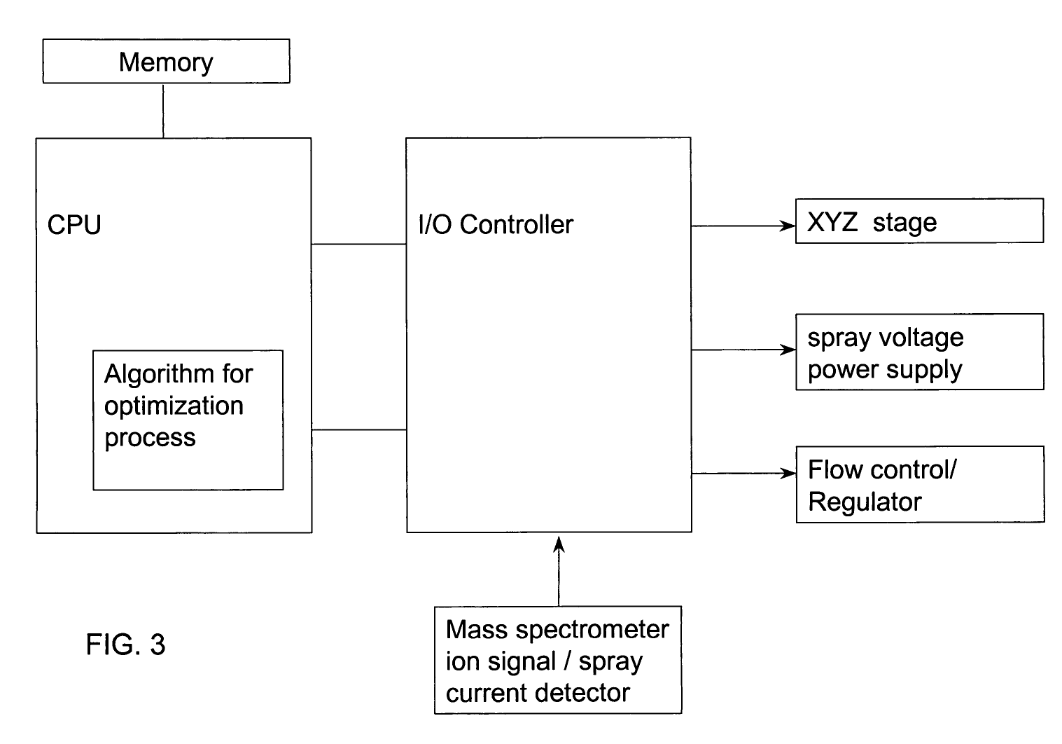

FIG. 3 illustrates a self-optimization system that automatically performs adjustments to electrospray conditions as needed to obtain predetermined optimal ion signals from a mass spectrometer. A selected liquid calibration or optimization solution containing one or more analytes is selected that should produce an expected signal or range of signals in the mass spectrometer and/or expected electrospray current. The solution may be fluidly connected to an electrospray tip or emitter that is mounted on an XYZ stage. The XYZ stage is controlled by an I/O controller to direct the movement of the electrospray tip in relation to the entrance of the mass spectrometer. The I/O controller can also be configured to communicate with a power supply which controls and regulates the spray voltage. Moreover, the flow controls for the solution and other selected fluids to be analyzed may receive commands from the I/O controller. The I/O controller may in turn be controlled and receive instructions from a central processing unit (CPU). The CPU may be coupled to a memory containing a computer program or optimization algorithm to solve for optimal spray parameters with predetermined variables. The memory may be a local memory or external memory relative to the CPU for containing an optimization program and algorithms along with previously determined electrospray conditions and collected data. The optimal values for these spray conditions may be also determined during prior experimentation and stored in memory for one or more optimization solutions for future reference. For example, the electrospray tip can be thus self-aligning in that the XYZ stage can be instructed to move to a predetermined optimal location so that the tip can be fixed in a particular spatial orientation relative to the counter electrode(s) at the entrance of a mass spectrometer. The flow control apparatus and voltage power supply can be similarly instructed to deliver previously determined optimal solution flow rates and spray voltages for that predetermined location and optimization solution.

The optimization process may be performed beforehand to ascertain certain optimal electrospray conditions such as the electrospray tip alignment, spray voltage and flow rate. For example, during the optimization procedure, the I/O controller may instruct a series of one or more motors to adjust alignment of the electrospray tip. The apparatus controlling spray voltage and flow rate may be also controlled during optimization in a feedback loop as spray conditions are being optimized. An algorithm can be developed and reside in a central processing unit (CPU) or coupled memory that can be executed to obtain an optimal signal in light of incoming mass spectrometer ion signals by adjusting a series of spray variables. Such variables include but are not limited to the XYZ position of an ESI device or tip, the electrospray voltage and flow rate for a selected calibration solution. The XYZ stage may be for example moved closer, further away from, or at an angle to the mass spectrometer entrance. Moreover, the voltage applied to the spray solution or to the electrospray needle can be adjusted up or down, and/or the flow rate may be increased or decreased as needed to arrive at an optimal set of electrospray ionization conditions. It shall be understood that the order or sequence of one or more adjustments for these and other spray variables can be altered as desired, and one or more variables may be held relatively fixed while others are modified. The position of the ESI device may remain constant at a predetermined position, for example, while the flow rate and/or spray voltage can be varied. During the optimization process, the position and spray voltage may be also kept the same while the flow rate is varied. The I/O controller can make necessary adjustments to these conditions in a feedback loop based on the optimization algorithm and information detected and measured relating to a selected electrospray parameter such as a signal from the mass spectrometer and/or electrospray current for the calibration solution. The mass spectrometer signal can also be used for calibration of the mass axis. Defined analytes with known m/z ratios provide expected signals in the mass spectrum for verification of a prior calibration measurement, or it can be used for establishing a new mass axis calibration.

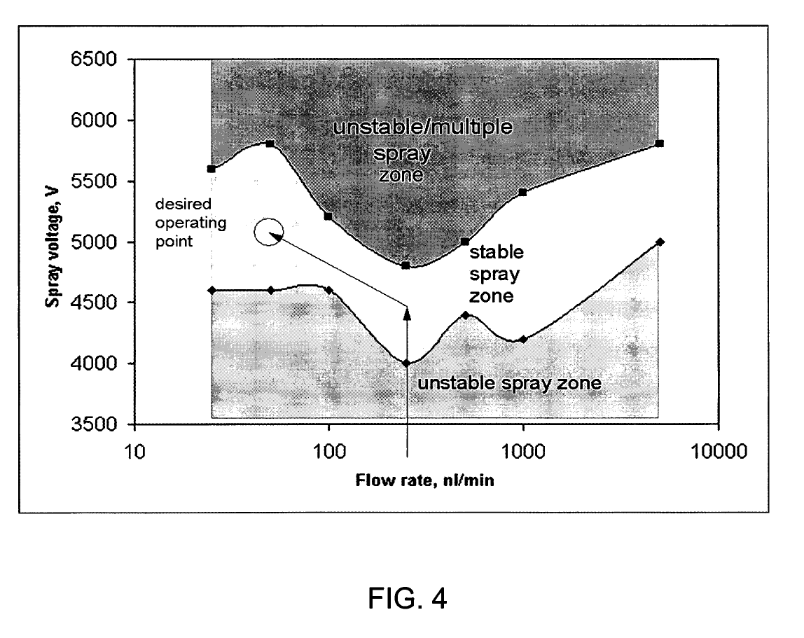

The optimization process provided in accordance with certain aspects of the invention is based in part at least on the observed effects that applied voltages have on the stability of an electrospray at various flow rates. As shown in the flow rate versus voltage graph in FIG. 4, there are certain regions of relative spray stability and instability observed at various spray voltages and flow rates ranging from below 100 nL/min to over 1000 nL/min. Below a certain lower limit or threshold voltage, the spray can be characterized as relatively unstable as illustrated in the unstable spray zone depicted in the graph. When operating above a certain upper limit voltage, the spray can be also considered relatively unstable which may even lead to multiple electrospray formation as indicated in the unstable/multiple spray zone region on the illustrated graph. But while operating within the observed voltage ranges at a selected flow rate, a relatively stable spray may be achieved. More particularly, within this range of stability, a desired operating point may be identified therebetween that lies substantially equidistant between the relative upper and lower voltage limits at a given flow rate. This “sweet spot” or desired operating point can be an optimal voltage that generates a relatively stable spray at a given flow rate which can be applied to the optimization apparatus and methods herein. Depending on the particular flow rate, a range may be provided to provide a stable spray despite some fluctuation in applied spray voltages. For example, at a flow rate of about 100 nL/min, it was observed that a range of spray voltages between approximately 4500 V to 5100 V produced a relatively stable spray. Beyond this desired voltage range, the spray can be considered relatively unstable based on certain desired electrospray characteristics and selected criteria. Accordingly, a desired nanospray operating point at approximately 5000 V may be thus identified within this range as illustrated. The respective voltage applied to the spray solution or to the electrospray emitter can be adjusted up or down to achieve this optimal spray condition in accordance with the invention.

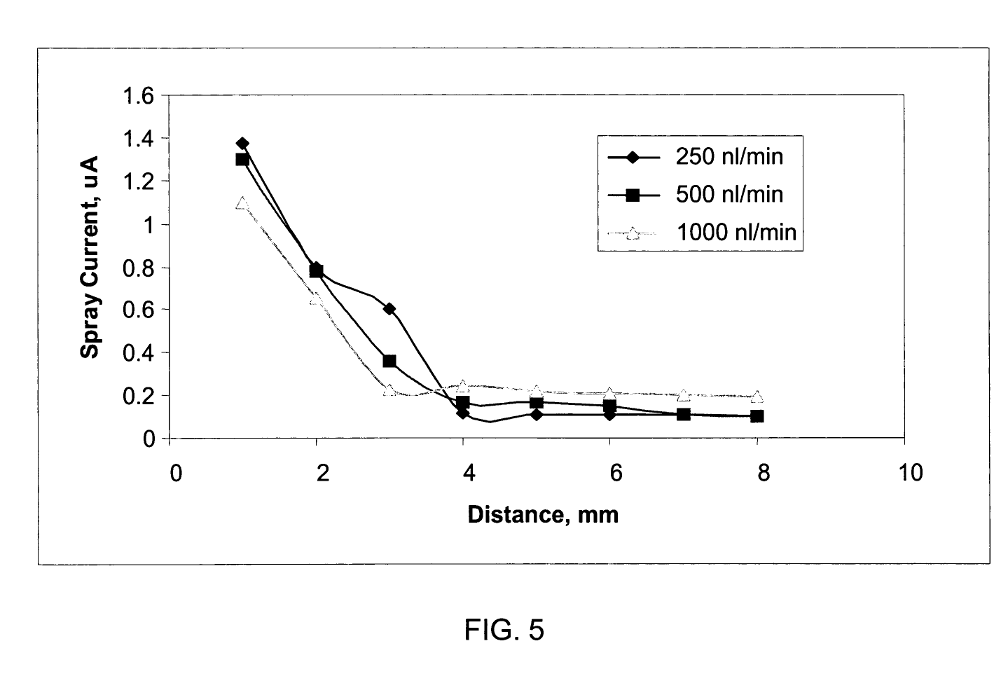

A relatively high stable electrospray current is also indicative of optimal spray conditions that can be provided herein by the invention. As shown in FIG. 5, a relatively high spray current can be observed when the relevant distance between an electrospray ionization tip and a test electrode is relatively small, e.g., about 1 mm. It has been generally observed that at relatively close distances, the electrospray currents are generally higher at relatively low flow rates, e.g., 1.4 uA@250 nL/min, and are generally lower at relatively high flow rates, e.g., 1.1 uA@1000 nL/min. However, as shown in the illustrated graph, the measured current levels generally decrease regardless of the rate of flow for distances between about 2 mm to 4 mm or greater away from the electrode. At distances greater than 4 mm, the current is at a relatively consistent level which suggests that spray stability in this range remains relatively unchanged even as the distance from the electrode increases. This observation concerning the relationship between distance and spray current generally held true at various flow rates ranging from 250, 500 and 100 nL/min. While this information was generated with experimentation using a test electrode, a mass analyzer could be alternatively selected instead which could possibly provide similarly high stable electrospray current at comparable distances from the electrospray tip.

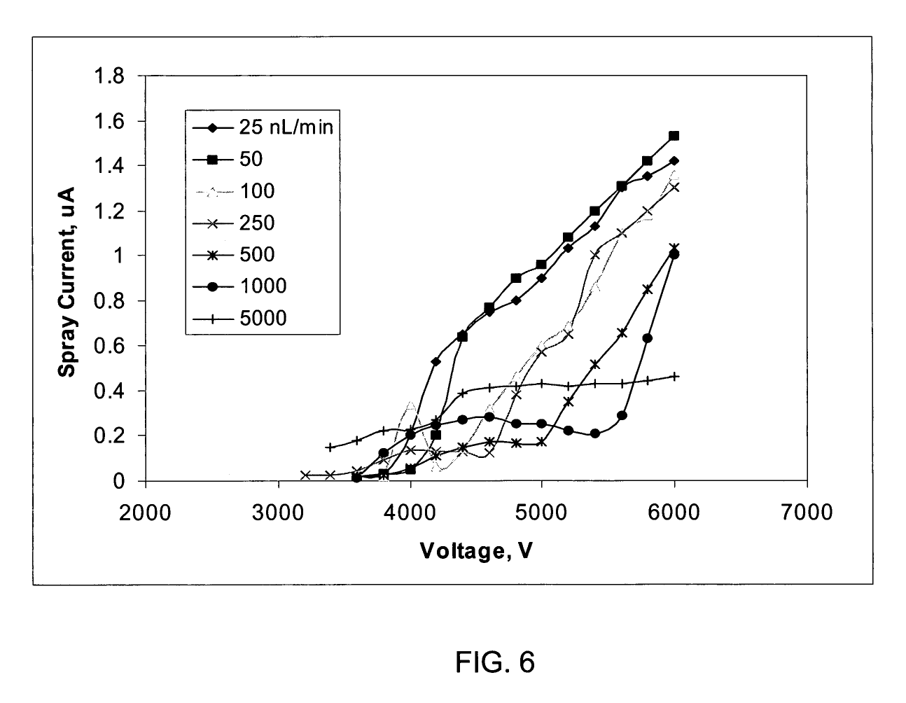

FIG. 6 depicts a graph illustrating the dependency of the electrospray current and voltage at different flow rates. A relatively high stable electrospray current is achieved with relatively higher voltages at various flow rates including 25, 50, 100, 250, 500, 1000 and 5000 nL/min. At relatively lower flow rates, it was generally observed that spray stability was linearly dependent upon an applied spray voltage ranging from about 3000 to 6000 V. Meanwhile, at relatively higher flow rates such as those greater than 250 nL/min, the relationship between electrospray current and voltage is observed to be non-linear across this voltage range. Accordingly, this relationship can enable a feedback mechanism that allows a user to alter the voltage in order to change the electrospray current with some level of predictability at certain flow rates in order to provide a relatively more stable electrospray. The electrospray voltage may be increased as needed to reach a desired current level in the event a spray becomes relatively unstable. The optimization apparatus and methods provided in accordance with the invention can automatically perform systemwide adjustments to produce an optimal and stable electrospray for mass analysis.

Another aspect of this invention provides optimization processes that are carried out by electrospraying an optimization solution and an analyte solution in succession or simultaneously. For example, the optimization step may be initially accomplished from a separate, but closely spaced electrospray tip or emitter that is substantially adjacent to a tip or emitter used for the analyte spray, or alternatively it may use the very same tip that is used for the analyte spray. The optimization may be done prior to and/or in succession with the electrospray of the analyte solution so that fewer or no adjustments are needed when performing electrospray for the analyte. This process may be monitored by observing one or more optimal electrospray characteristics such as a constant electrospray current, a stable Taylor cone formation, a high, stable signal for internal standard(s), and reduced or minimal background signal from the selected solvent selected for the electrospray. In this embodiment of the invention, the electrospray source for the optimization solution can be mounted on an XYZ positioning stage as described elsewhere herein to change its relevant position to a mass spectrometer, while the electrospray source for the analyte solution can be similarly mounted on such apparatus and subsequently moved into position to deliver a spray at a desired flow rate. After completing the optimizing process using the optimization solution, the electrospray source for the analyte solution may be positioned in place to deliver a spray to generate a mass spectrum from the electrosprayed ions. In this manner, an optimization mass spectrum can be acquired prior to obtaining the mass spectrum of an analyte sample. The optimization mass spectrum and the analyte mass spectrum can be thus analyzed together in a data system prior to calculating the mass assignment of the sample related peaks.

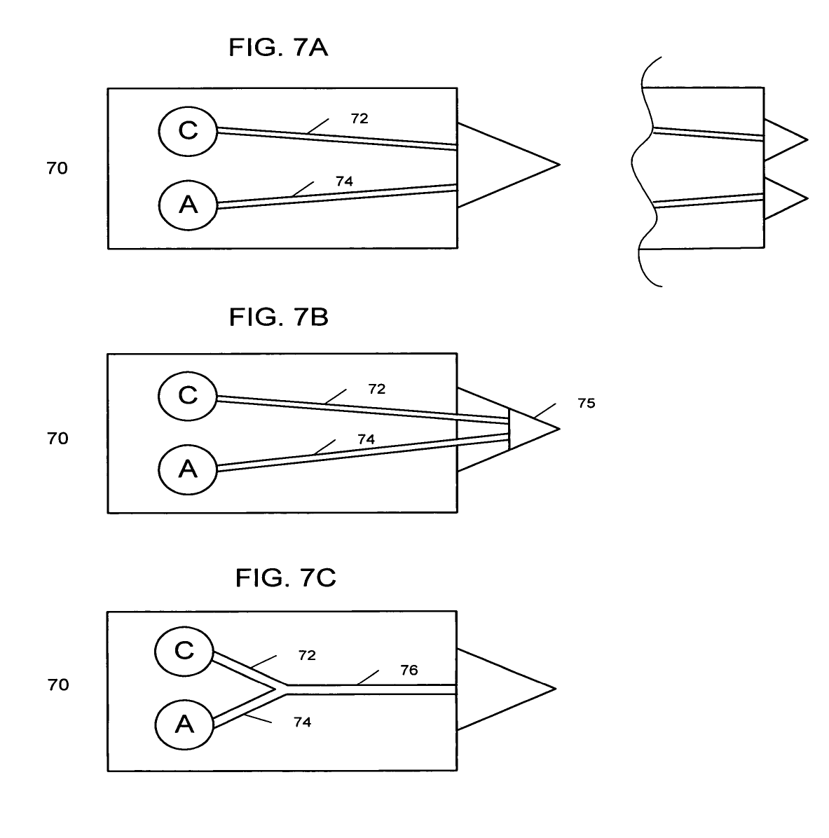

Alternatively, the optimization step may be performed from a common microfluidic chip or ESI device formed with one or more tips or emitters as shown in FIGS. 7A-C. In this embodiment of the invention, the tip(s) for the analyte and optimization solutions can be positioned in close proximity relative to each other and a mass spectrometer which can be desirable for certain applications. As shown in FIG. 7A, the electrospray can be generated from a single microfluidic chip 70 having separate channels 72 and 74 upstream of the electrospray needle/emitter for supply of a calibrant or optimization solution, and an analyte solution from reservoirs (C) and (A) respectively. The calibrant and analyte solutions can be delivered in separate channels 72 and 74 and reservoirs (C) and (A), but sprayed from a common emitter. Alternatively, each channel 72 and 74 may lead to a separate emitter formed on the chip 70 as shown. In another embodiment, the multiple separate channels 72 and 74 may converge at a common distal tip region 75 as shown in FIG. 7B. Other microfluidic chips may be selected for optimization in accordance with the invention herein such as those described in pending application U.S. Ser. No. 10/649,350 filed on Aug. 26, 2003 which is incorporated by reference in its entirety herein. The fluid channels 72 and 74 formed in the microfluidic chip 70 may also intersect and converge with a common channel 76 leading to the electrospray tip in yet another embodiment of the invention as shown in FIG. 7C. Additional channels may be formed in these chips for directing a nebulizing solution to assist in stabilization of the electrospray. These single microfluidic chips may be single-use components and utilized rather than multiple devices which could help reduce waste.

The electrospray optimization methods and apparatus herein are performed with single or multi-tip electrospray emitter that can simultaneously or sequentially deliver a calibrant and one or more analyte solutions. The locality of the electrospray emitter can often reduce or eliminate the need to re-position the device relative to a mass spectrometer which could again require the optimization process to be performed. These variations of the invention thus provide concurrent or successive spraying of both analyte and optimization solutions with the microfluidic chips such as those described in FIGS. 7A-C. For example, the calibrant and an analyte solution can be delivered through the same channel 76. The calibrant can be sprayed initially and then followed by the analyte solution in a serial manner, or both can be co-mixed and analyzed as a single combination. The calibrant can be thus measured simultaneously with the analyte measurement in order to achieve and maintain an optimal electrospray signal if desired. Alternately, the calibrant and analyte solutions may be mixed before loading on the microfluidic chip, and sprayed simultaneously from a single reservoir (A) or (C) through the channel 76.

While the invention has been described with reference to the aforementioned specification, the descriptions and illustrations of the preferable embodiments herein are not meant to be construed in a limiting sense. It shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art upon reference to the present disclosure. It is therefore contemplated that the appended claims shall also cover any such modifications, variations and equivalents.

1. An electrospray ionization (ESI) device for mass spectrometric analysis comprising:
a fluidic chip formed with an electrospray emitter fluidly connected to a calibration solution that produces an expected ESI signal in a mass spectrometer;
an input/output (VO) controller that is coupled to an electrospray assembly including at least one of the following: an XYZ stage to position the electrospray emitter relative to a mass spectrometer orifice; a power supply connected to the fluidic chip for applying an adjustable electrospray ionization voltage; and an adjustable flow regulator connected to the fluidic chip for regulating flow of the calibration solution; and
a central processing unit coupled to a memory having an optimization algorithm for optimizing electrospray conditions of the calibration solution by instructing the I/O controller to selectively control the electrospray assembly based on resultant signals from the mass spectrometer to achieve the expected ESI signal for the calibration solution.

2. The ESI fluidic device as recited in claim 1, wherein the ESI fluidic chip is a microfluidic chip.

3. The ESI fluidic device as recited in claim 1, wherein the power supply is also connected to the mass spectrometer orifice.

4. A method of obtaining optimal electrospray ionization (ESI) conditions comprising the following steps of:
selecting an automated ESI optimization assembly for controlling an electrospray ionization interface that includes a microfluidic device and a mass spectrometer for measuring expected ESI signals for the calibration standard;
selecting a set of initial spray conditions including an initial position, an ESI voltage and a flow rate for the calibration standard;
applying the set of initial spray conditions to the electrospray ionization interface using the ESI optimization assembly to generate resulting ESI signals for the calibration standard in the mass spectrometer;
measuring the resulting ESI signals for the calibration standard in the mass spectrometer; and
adjusting at least one initial spray condition with the automated ESI optimization assembly until the expected or optimal ESI signals for the calibration standard are obtained.

5. The method as recited in claim 4, wherein the expected ESI signals are observed and characterized by at least one of the following: a substantially constant electrospray current, a relatively stable Taylor cone formation, a relatively high, stable detected ion signal for the calibration standard(s), and a relatively high, stable current at selected locations within the mass spectrometer.

6. The method as recited in claim 4, wherein at least one of the initial spray conditions is adjusted according to an automated feedback loop based on the resulting ESI signals for the calibration standard in the mass spectrometer.

7. The method as recited in claim 4, wherein the ESI optimization assembly includes a controller to control positioning of an XYZ stage on which the microfluidic device is mounted.

8. The method as recited in claim 4, wherein the ESI optimization assembly includes a controller to control delivery of power to a voltage source that generates the ESI voltage.

9. The method as recited in claim 4, wherein the ESI optimization assembly includes a controller to control flow from a fluid source that delivers the calibration standard.

10. The method as recited in claim 7, wherein the microfluidic device mounted on the XYZ stage is moved to a desired location relative to the entrance of a mass spectrometer that is derived from prior experimentation.

11. The method as recited in claim 10, wherein the XYZ stage includes at least one of the following: a single-dimension translation; a two-dimension translation; and a three-dimension translation.

12. A method for optimizing an electrospray ionization (ESI) process comprising the following steps of:
selecting a microfluidic device formed with an electrospray tip, wherein the microfluidic device includes: at least one analyte reservoir for supplying to the electrospray tip an analyte solution through a first channel formed in the device; and a calibrant reservoir for supplying to the electrospray tip a calibrant that generates an optimal value for a selected ESI parameter through a second channel formed in the device;
positioning the electrospray tip relative to an orifice in the mass spectrometer;
introducing an electrospray of the calibrant into the orifice of the mass spectrometer by implementing an initial set of electrospray interface conditions;
measuring the selected ESI parameter resulting from implementation of the initial set of electrospray interface conditions; and
automatically adjusting at least one of the electrospray interface conditions using an automated ESI optimization assembly to obtain the optimal value for the selected ESI parameter.

13. The method as recited in claim 12, wherein the selected ESI parameter is an expected ESI signal in the mass spectrometer for the calibrant.

14. The method as recited in claim 12, wherein the selected ESI parameter is an expected ESI current for the calibrant.

15. The method as recited in claim 12, wherein the optimal value for the selected ESI parameter falls within a range of preferred values.

16. The method as recited in claim 12 further comprising the step of:
introducing an electrospray of the analyte solution into the orifice of the mass spectrometer to generate a mass spectrum or spectra for the analyte solution.

17. The method as recited in claim 16, wherein the first channel and the second channel are non-converging channels.

18. The method as recited in claim 16, wherein the first channel and the second channel are converging channels that permit mixing of the analyte solution from the first channel and the calibrant from the second channel.

19. The method as recited in claim 18, wherein the first channel and the second channel converge with a third channel which leads to the electrospray tip.

20. The method as recited in claim 19, wherein the electrospray of the calibrant is introduced into the mass spectrometer orifice before the electrospray of the analyte solution is introduced into the mass spectrometer orifice.

21. The method as recited in claim 16, wherein the electrospray of the calibrant is introduced into the mass spectrometer orifice before the electrospray of the analyte solution is introduced into the mass spectrometer orifice.

22. The method as recited in claim 18, wherein the first channel and the second channel converge at the electrospray tip.

23. The method as recited in claim 16, wherein the electrospray of the calibrant is introduced into the mass spectrometer orifice simultaneously as a co-mixture with the analyte solution.

24. The method as recited in claim 16, wherein the selected ESI parameter is an optimal ESI signal for the calibrant that is measured simultaneously with the analyte solution.
